(19) United States
(12) Patent Application Publication
(10) Pub. No.: US 2005/0286037 A1
(43) Pub. Date: Dec. 29, 2005

(54) Semiconductor exposure apparatus and method for exposing semiconductor using the same

(75) Inventor: No Young Chung, Icheon-city (KR)

Correspondence Address: THE LAW OFFICES OF ANDREW D. FORTNEY, PH.D., P.C., 7257 N. MAPLE AVENUE, BLDG. D, SUITE 107, FRESNO, CA, 93720, US

(73) Assignee: DongbuAnam Semiconductor Inc.

(21) Appl. No.: 11/166,647

(22) Filed: Jun. 23, 2005

(30) Foreign Application Priority Data
Jun. 24, 2004 (KR) 10-2004-0047740

(51) Int. Cl. G03B 27/74

(52) U.S. Cl. 355/69; 356/121; 355/77

(57) ABSTRACT

A semiconductor exposure apparatus and a method for exposing a semiconductor using the same are disclosed, which can prevent differences in critical dimensions according to variations in slit intensity profile of exposure light passing through a slit. The apparatus comprises a module for adjusting a slit intensity profile of exposure light passing through the slit, and a sensor for checking an optimized slit intensity profile. It is possible to optimize the slit intensity profile of the exposure light according to various intensity establishments. Additionally, since a difference in intensity of light in an X direction of the slit is decreased, uniformity of a CD within a field is enhanced.

This application claims the benefit of Korean Patent Application No. P2004-47740, filed on Jun. 24, 2004, which is hereby incorporated by reference as if fully set forth herein.

### BACKGROUND OF THE INVENTION

1. Field of the Invention

The present invention relates to manufacturing of a semiconductor device, and more particularly, to a semiconductor exposure apparatus and a method for exposing or irradiating a semiconductor using the same, which can prevent a difference in pattern critical dimensions from occurring due to variations in the slit intensity profile of exposure light passing through a slit.

2. Discussion of the Related Art

Generally, among processes of manufacturing a semiconductor device, an exposure process is a process for forming a predetermined pattern on a semiconductor wafer by selectively exposing the wafer to a light source of an exposure apparatus (e.g., photolithography equipment) after applying a photoresist to the wafer. Such an exposure apparatus for forming a semiconductor pattern will be described with reference to the drawings as follows.

FIG. 1 is a schematic representation illustrating the structure of a conventional semiconductor exposure apparatus.

As shown in FIG. 1, the conventional semiconductor exposure apparatus comprises a condenser lens 1 serving to condense light emitted from a light source (not shown), a reticle (or mask) 2 for forming a circuit pattern on a semiconductor wafer by allowing the light emitted from the condenser lens 1 to be selectively transmitted therethrough, a projection lens system 3 for condensing the light passing through the reticle 2 to a predetermined size, and a wafer stage 4 located below the projection lens system 3 for locating the semiconductor wafer to be patterned.

The semiconductor exposure apparatus constructed as described above is operated in such a manner that, after light emitted from the light source (not shown) passes through the condenser lens 1, the reticle 2, and the projection lens system 3, the semiconductor wafer having the photoresist applied thereto is exposed to light, whereby the circuit pattern of the reticle 2 is formed on the semiconductor wafer.

Recently, in such a semiconductor exposure apparatus, as the critical dimension (hereinafter referred to as “CD”) of a pattern has decreased, a CD control range for a target CD to be patterned has also been decreased.

As the CD control range has decreased, the influence of the slit intensity profile of light passing through a slit on the CD increases. In the case of a scanner, a slit of a predetermined size (8 mm×26 mm) is located in an exposure path so as to allow the reticle to be scanned to an acceptable extent. As a result, in such a scanner, variations in the slit intensity profile in an X direction (slit direction, or along the longest axis of the slit) cause a difference in the CDs corresponding to this variation.

Additionally, when using the scanner for a long time, optical systems including the projection lens systems may become contaminated, causing an initially optimized state of the slit intensity profile of the scanner to be changed, thereby requiring the slit intensity profile to be reoptimized.

Accordingly, conventionally, in order to correct the slit intensity profile, a method has been used in which the slit intensity profile is checked and optimized at an initial exposure stage, and is corrected after a predetermined period.

However, the method has a problem in that, after the predetermined period, uniformity of the CD is inevitably degraded and requires time consumption in order to optimize the slit intensity profile, thereby lowering productivity.

### SUMMARY OF THE INVENTION

Accordingly, the present invention is directed to a semiconductor exposure apparatus and a method for exposing or irradiating a semiconductor using the same that substantially obviate one or more problems due to limitations and disadvantages of the related art.

An object of the present invention is to provide a semiconductor exposure apparatus and a method for exposing a semiconductor wafer using the same, which can correct a slit intensity profile of exposure light passing through a slit prior to exposing the wafer during a process of manufacturing a semiconductor.

Additional advantages, objects, and features of the invention will be set forth in part in the description which follows and in part will become apparent to those skilled in the art upon examination of the following or may be learned from practice of the invention. The objectives and other advantages of the invention may be realized and attained by the structure(s) particularly pointed out in the written description and claims hereof as well as the appended drawings.

To achieve these objects and other advantages and in accordance with the purpose of the invention, as embodied and broadly described herein, a semiconductor exposure apparatus using a slit is provided, comprising: a module for adjusting a slit intensity profile of exposure light passing through the slit; and a sensor for checking an adjusted slit intensity profile.

In another aspect of the present invention, a method for exposing a semiconductor wafer to or irradiating the semiconductor wafer with light passed through a slit, comprising the steps of: checking a slit intensity profile of exposure light prior to exposing the semiconductor wafer; and, when the checked slit intensity profile does not have a predetermined light intensity, adjusting the slit intensity profile to the predetermined light intensity.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic diagram illustrating the structure of a conventional semiconductor exposure apparatus;

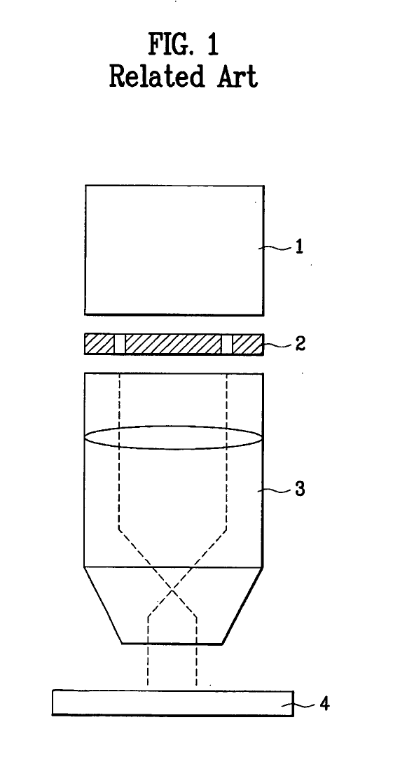

FIG. 2 is a schematic diagram illustrating the structure of a semiconductor exposure apparatus in accordance with the present invention; and

FIG. 3 is a diagram illustrating an inner structure of a slit intensity profile optimization module in accordance with the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

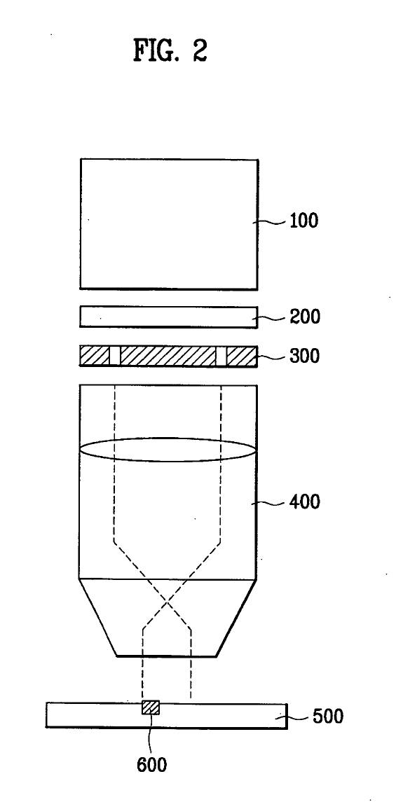

FIG. 2 is a schematic diagram illustrating the structure of a semiconductor exposure apparatus in accordance with the present invention.

Referring to FIG. 2, a scanner type exposure apparatus for a semiconductor wafer may comprise a condenser lens assembly 100 serving to condense or focus light emitted from a light source (not shown), a slit intensity profile adjusting module 200 for adjusting intensity of light emitted from the condenser lens assembly 100, a reticle (or mask) 300 for forming a circuit pattern on the semiconductor wafer in such a manner of allowing the light emitted from the module 200 to be selectively transmitted therethrough, a projection lens system 400 for condensing or focusing the light passing through the reticle 300 to a predetermined size (or width), a wafer stage 500 located below the projection lens system 400 for locating the semiconductor wafer to be patterned, and an intensity check sensor 600 attached to a predetermined position of the wafer stage 500 for checking the intensity of light. In practice, the reticle may be replaced, and as a result, the apparatus may comprise a reticle holder (as opposed to or in addition to the reticle).

Although not shown in the drawings, a slit is provided between the condenser lens assembly 100 and the slit intensity profile adjusting module 200 or between the slit intensity profile adjusting module 200 and the reticle 300 so as to allow the reticle 300 to be scanned to an acceptable extent thereof. The slit generally is formed in a disc, plate or cover placed in front of or on the condenser lens assembly 100 or the slit intensity profile adjusting module 200 such that exposure light passes through it. The slit generally has a size of 8 mm×26 mm, and permits a substantial exposure area of about 26 mm×33 mm when the reticle 300 and the wafer are exposed or irradiated while moving them at a predetermined speed ratio. As such, when using the slit as described above, since it is possible to use a single lens having a length of 26 mm, there are advantages in that any adverse influence of lens aberrations is low, the number of openings can be easily determined, and it is possible to expose an increased area of the wafer through the scan type exposure in comparison to a conventional stepper.

Operation of the exposure apparatus for the semiconductor wafer constructed as described above and in accordance with the invention will be described as follows.

First, light generated from a light source (not shown) is condensed and emitted through the condenser lens assembly 100. The condenser lens assembly 100 comprises two or more condenser lenses, and a fly eye's lens between the condenser lenses for enhancing uniformity of the light therebetween, so that uniformly condensed light is emitted through the condenser lens assembly 100.

The intensity of the light from the condenser lens assembly 100 may be controlled by and subsequently emitted through the slit intensity profile adjusting module 200 of the invention. Then, the light is passed or projected through the reticle 300 and the projection lens system 400. Reticle 300 generally has a pattern thereon for a layer in a circuit design. After passing through projection lens system 400, a wafer (not shown) on the wafer stage 500 and having photoresist applied thereto is exposed to or irradiated with the light according to the circuit pattern on the reticle 300.

At this time, according to the invention, wafer batch units (generally about 25 wafers) are exposed after determining an optimum slit intensity profile using the intensity check sensor 600 attached to the wafer stage 500.

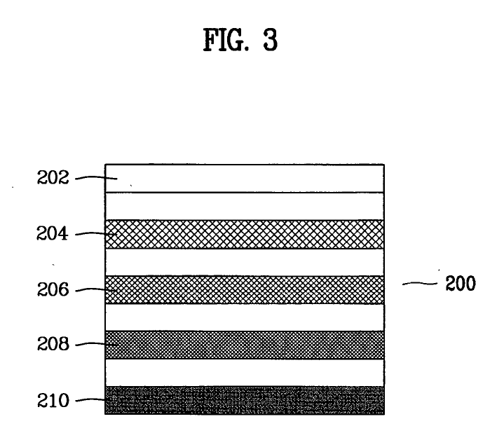

For this purpose, the intensity profile adjusting module 200 may be equipped with at least two optical systems having different transmittances to adjust the intensity of light, which will be described with reference to FIG. 3.

FIG. 3 is a diagram illustrating an inner structure of the slit intensity profile adjusting module of the invention.

As shown in FIG. 3, the intensity profile adjusting module 200 is equipped with at least two optical systems having different transmittances to adjust the intensity of light. For example, FIG. 3 shows a combination of five optical systems having different transmittances. However, the number of optical systems may be two, three, four, five or more, depending on the capabilities of the exposure apparatus (e.g., photolithography equipment such as a scanner) and/or corresponding control system and/or the desired level of optimization.

Accordingly, the at least two optical systems having different transmittances within the intensity profile adjusting module 200 are combined according to a desired intensity of exposure light using the intensity check sensor 600 attached to the wafer stage 500, so that exposure of the wafer is performed after providing and/or determining the optimum slit intensity profile for one or more wafer batch units (or “lots”). In one embodiment, the intensity of exposure light is determined for each wafer batch unit or lot.

That is, when the intensity of light detected at the intensity check sensor 600 is not the preset or predetermined intensity (or does not have an intensity value within a preset or predetermined intensity range) for one or more wafer batches, exposure of the wafers is performed after adjusting the slit intensity profile of the exposure light through the intensity profile adjusting module 200.

As is shown in FIG. 3, the at least two optical systems may comprise a series of filters 202, 204, 206, 2008 and 210 having a range of predetermined light absorbing properties. For example, the filters may have a light absorbance of from about 0% (e.g., for first filter 202) up to about 80% (e.g., for fifth filter 210), generally for the wavelength of the exposure light. The filters in the series may have light absorbing and/or transmitting properties that may differ from adjacent filters in the at least two optical systems by a predetermined proportion or amount (e.g., from 5 to 50%, from 10 to 25%, or any other range of values therein) Also, the filters may be adapted such that a first optical system or filter having a first light absorbance and/or transmittance may be applied to a first region of the slit (e.g., a center region) and one or more additional filters (each having a different light absorbance and/or transmittance) applied to one or more corresponding regions of the slit other than the first region (e.g., one or more peripheral or end regions). Thus, the step of adjusting the slit intensity profile may comprise passing the exposure light through a different one of the at least two optical systems.

As apparent from the above description, the scanner type semiconductor exposure apparatus and the method of the same according to the invention have advantageous effects as follows.

Firstly, it is possible to optimize the slit intensity profile of exposure light according to various intensity levels.

Secondly, since a difference in intensity of the light in the X direction of the slit is decreased, uniformity of the CD within a field is enhanced.

Thirdly, since expensive equipment is not required to optimize the slit intensity profile at every predetermined time (e.g., at the beginning of a wafer lot), semiconductor manufacturing productivity is enhanced.

It will be apparent to those skilled in the art that various modifications and variations can be made in the present invention without departing from the spirit or scope of the inventions.

Thus, it is intended that the present invention covers the modifications and variations of this invention provided they come within the scope of the appended claims and their equivalents.

1. A semiconductor exposure apparatus having a slit, comprising:
a module for adjusting a slit intensity profile of exposure light passing through the slit; and
a sensor for checking an adjusted slit intensity profile.

2. The apparatus according to claim 1, wherein the module comprises at least two optical systems having different transmittances.

3. The apparatus according to claim 2, wherein the at least two optical systems comprise a plurality of filters.

4. The apparatus according to claim 2, wherein the transmittances of the at least two optical systems differ by an amount of from 5% to 50%.

5. The apparatus according to claim 4, wherein the transmittances of the at least two optical systems differ by an amount of from 10% to 25%.

6. The apparatus according to claim 1, further comprising a condenser lens.

7. The apparatus according to claim 6, further comprising a reticle holder.

8. The apparatus according to claim 7, wherein the module is located between the condenser lens and the reticle holder.

9. The apparatus according to claim 1, further comprising a wafer stage, wherein the sensor is on the wafer stage.

10. A method for exposing a semiconductor wafer using a slit, comprising the steps of:
checking a slit intensity profile of exposure light prior to exposing the semiconductor wafer; and,
when the checked slit intensity profile does not have a predetermined light intensity, adjusting the slit intensity profile to the predetermined light intensity.

11. The method according to claim 10, further comprising repeating the step of checking the slit intensity profile and the step of adjusting the slit intensity profile for each wafer batch unit.

12. The method according to claim 10, wherein the step of adjusting the slit intensity profile is performed using at least two optical systems having different transmittances.

13. A method for adjusting exposure of a semiconductor wafer, comprising the steps of:
checking a slit intensity profile of exposure light prior to exposing the semiconductor wafer exposure light to, or irradiating the semiconductor wafer with, the exposure light; and
when the checked slit intensity profile does not have an intensity within a predetermined light intensity range, adjusting the slit intensity profile to within the predetermined light intensity range.

14. The method according to claim 13, further comprising repeating the step of checking the slit intensity profile and the step of adjusting the slit intensity profile for each wafer batch unit or lot.

15. The method according to claim 13, wherein the step of checking the slit intensity profile comprises sensing the exposure light at a location on a wafer stage.

16. The method according to claim 13, further comprising passing the exposure light through one of at least two optical systems in a light intensity adjusting module.

17. The method according to claim 16, wherein the step of adjusting the slit intensity profile comprises passing the exposure light through a different one of the at least two optical systems.

18. The method according to claim 16, wherein each of at least two optical systems comprises a filter having a corresponding light transmittance.
